(19) United States
(12) Patent Application Publication
(10) Pub. No.: US 2026/0176848 A1
(43) Pub. Date: Jun. 25, 2026

(54) BATH FAUCET WATER FILTER

(71) Applicant: Filterbaby LLC, Gaithersburg, MD (US)

(72) Inventors: Xin Ma, Gaithersburg, MD (US); Harry Mitchell, Gaithersburg, MD (US); Mark Reilly, Gaithersburg, MD (US)

(21) Appl. No.: 19/000,485

(22) Filed: Dec. 23, 2024

(51) Int. Cl. E03C 1/04; C02F 1/00

(52) U.S. Cl. CPC E03C 1/04; C02F 1/002; C02F 2201/006; C02F 2307/06; E03C 2201/40

(57) ABSTRACT

A bath faucet water filter may include a universal bath faucet connector including a strap and a hanger member that is configured to extend from the strap when the strap is engaged with a bath water faucet. A bath water filter housing that defines a cavity within which a replaceable water filter is positioned, and configured to be suspended by the hanger member in an upright position when the hanger member extends horizontally, vertically, or diagonally when the strap is engaged with a corresponding bath water faucet.

### BACKGROUND

Bath water faucets or bath faucets, come in all shapes, materials, finishes, sizes, and orientations. Some bath faucets are round, some are rectangular, some are long, some are short, some are wide, some are narrow, some are metallic (e.g., copper, chrome finish, steel, etc.), some have smooth finishes, and some have rough finishes. The bath water faucets, irrespective of the size, shape, or length, may have shafts that extend horizontally, vertically, or diagonally.

### SUMMARY

To support a bath faucet water filter by a bath water faucet or bath faucet of any variation (e.g., shape, size, material, finish, and/or orientation), a universal connector hanger, inclusive of a strap and hanger member may be utilize to interface with bath faucets of any variation. The universal connector hanger may support a bath faucet water filter housing by a handle configured to interface or engage with the hanger member of the universal connector hanger. In an embodiment, the strap may be flexible and include a surface that interfaces with bath faucets of any variation in a manner that limits or prevents relative translational motion of the bath faucet water filter. The material may include or be formed of silicone, rubber, or other flexible material that minimizes or prevents relative motion of a bath faucet of any variation.

The universal connector hanger may include a connector adapter that is retained by the strap in a manner that accommodates any variation of bath faucet. For example, a length of the hanger member from a base to an engagement location of a head may be longer than half the width of a handle configured to support the bath filter housing, thereby being configured to maintain the bath filter, housing in an upright orientation for any variation of bath water faucet. The bath filter housing may be configured to support a water filter used to filter water that is input into the bath filter housing from the bath faucet. In an embodiment, the bath filter housing may further be configured to enable a skin treatment component to be positioned downstream and fluidly disposed between an output of the water filter and output of the bath housing water filter by treating filtered water.

### BRIEF DESCRIPTION OF THE FIGURES

A more complete understanding of the method and apparatus of the present invention may be obtained by reference to the following Detailed Description when taken in conjunction with the accompanying figures wherein:

FIGS. 1A-1G are illustrations of an illustrative bath faucet water filter configured to be utilized with any variety of bath water faucets;

FIGS. 2A-2D are illustrations of illustrative scenes or configurations in which the bath faucet water filter of FIGS. 1A-1G are shown to be supported by bath faucets; and

FIGS. 3A and 3B are exploded and side assembled views, respectively of an illustrative bath faucet water filter and components thereof.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

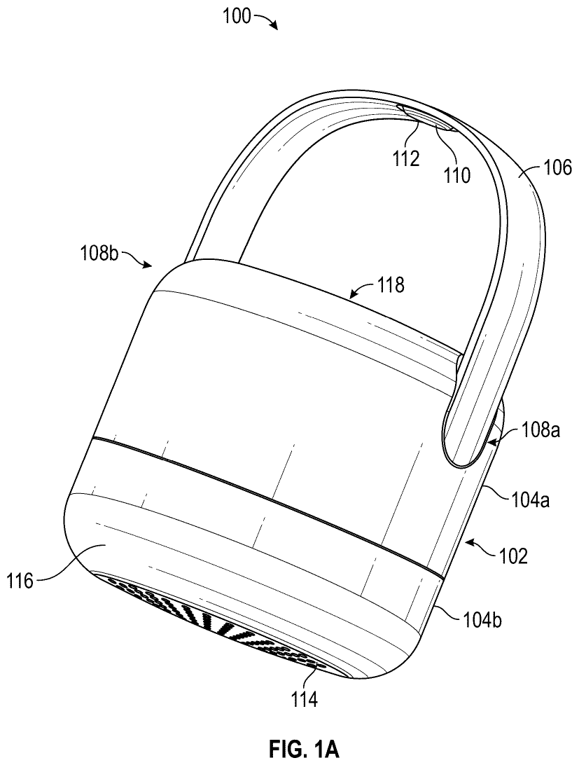

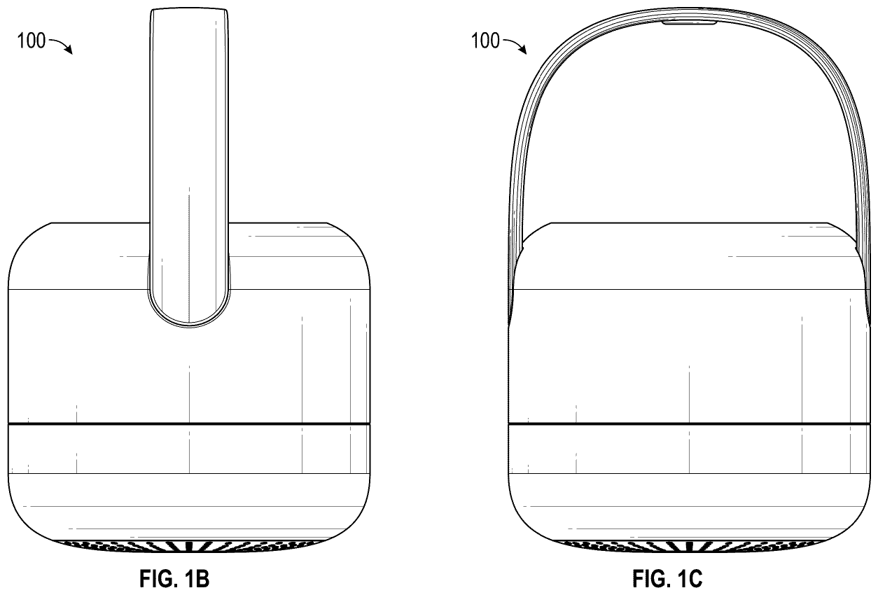

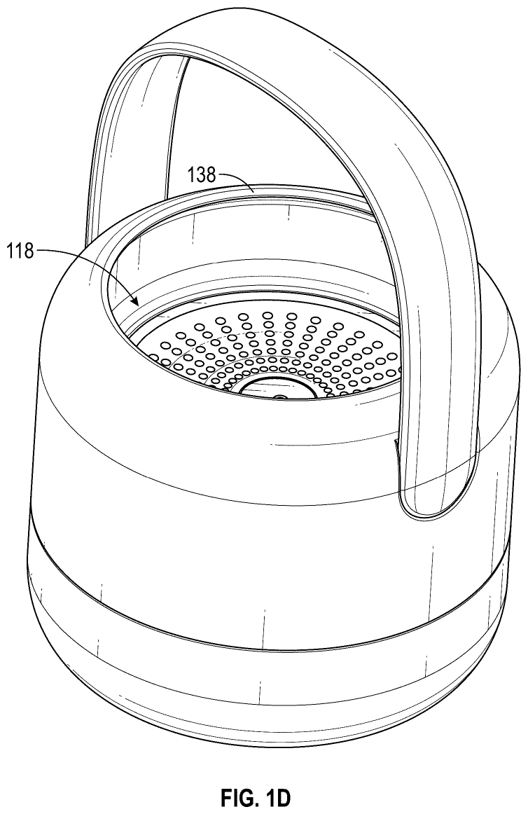

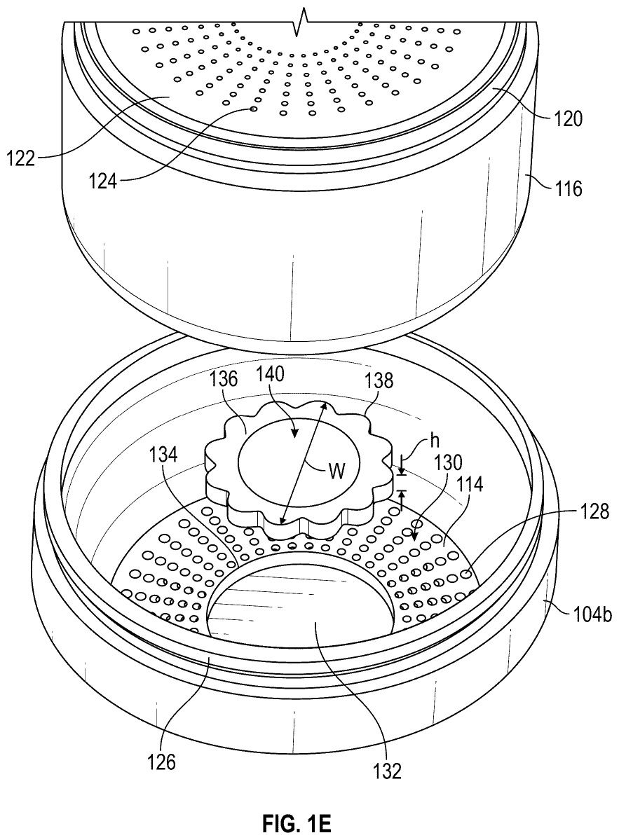

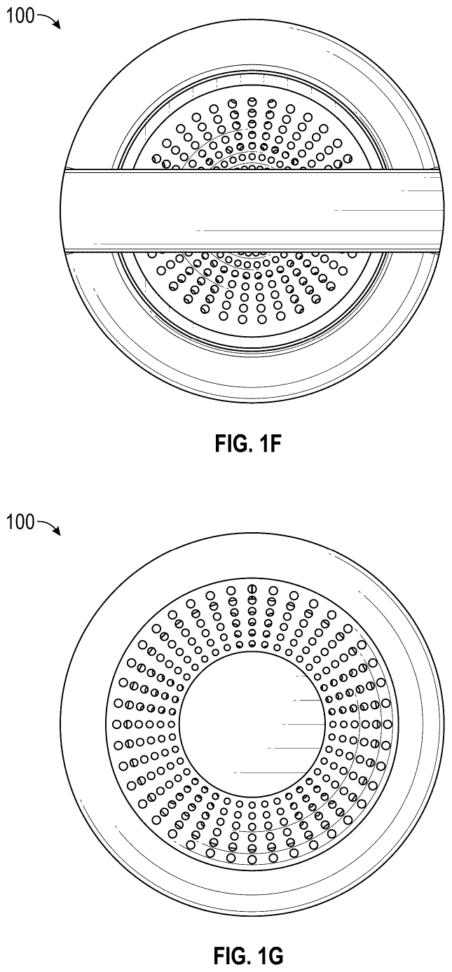

With regard to FIGS. 1A-1G, illustrations of an illustrative bath faucet water filter 100 configured to be utilized with any variety of bath water faucets are shown. The bath faucet water filter 100 may include a housing or shell 102 including an upper or top housing 104a and a lower or bottom housing 104b (collectively 104). In an embodiment, the upper and lower housings 104 may have corresponding threads that enable the upper and lower housings 104 to be screwed together. Alternative mechanisms of separating and joining the upper and lower housings 104 may be utilized to form the housing or shell 102 and prevent water from leaking during operation (e.g., clamps, snaps, etc., to retain the upper and lower housings 104 together with a gasket or seal therebetween to prevent water leakage). In an embodiment, the upper housing 104a may be opaque and the lower housing 104b may be transparent or translucent. In another embodiment, both the upper and lower housings 104 may be opaque, translucent, or transparent.

A handle 106 may be configured to be fixedly or releasably attached to the upper portion 104a of the housing 102 at handle attachment regions 108a and 108b (collectively 108). The handle 106 may include one or more features (not shown) that are used to fixedly or releasably attach to upper housing 104a at the handle attachment regions 108. In an embodiment, the handle 106 may be rotatably attached to the upper housing 104a such that the handle 106 and upper housing 104a are rotatable relative to one another. In another embodiment, the handle 106 and upper housing 104a have limited or no relative rotation due to one or more complimentary features on one or both of the handle 106 and upper housing 104a. The handle 106 may be flexible, semi-rigid (i.e., a structured shape that is bendable), or rigid (i.e., not easily bent). The handle 106 may be formed of a thermoplastic, metal, or any other material that is capable of supporting the housing 102 when a water filter is contained therein and water from a bath faucet is dispensed into the housing 102. The shape of the handle 106 may be as shown or may have any other shape.

The handle 106 may include an adapter interface structure 110 that defines an adapter interface structure engagement region 112. In an embodiment, the adapter interface structure 110 may include one or more protrusions that define an indentation for a suspension member to engage in supporting the bath faucet water filter 100. In an alternative embodiment, the adapter interface structure 110 may be a separate component that connects to or interfaces with the handle 106. The adapter interface structure 110 may be positioned at a center region of the handle 106 so as to be balanced when suspended by a suspension member. Rather than having a single adapter interface structure 110, multiple adapter interface structures 110 may be positioned on an underside of the handle. In an alternative embodiment, an adapter interface structure (e.g., eye, loop, etc.) connected to or integrally formed as part of the handle 106 having the ability to be hooked or otherwise engaged by a suspension member may be utilized in accordance with the principles described herein. At the bottom of the lower housing 104b, a base drainage member 114 may be positioned to cause water passing through the bath faucet water filter to be evenly distributed due to the base drainage member 114 defining evenly spaced openings. Alternative configurations of the base drainage member 114 may be utilized, as well.

As further shown, a water filter 116 may be seen via the lower housing 104b that is translucent. The water filter 116 may be configured within the housing 102 in a manner that forces water that enters through an opening 116 defined by the upper housing 104a from a bath water faucet. The water filter 116 may have any size and shape that fits within the housing 102 capable of performing the function of filtering water and a rate at which water flows from a bath water faucet into the bath faucet water filter 100.

With regard to FIGS. 1B, 1C, 1D, 1F, and 1G, respective side, front, top perspective, top, and bottom views of the bath faucet water filter 100 are shown.

With regard to FIG. 1E, a view of the lower housing 104b separated from the upper housing 104a of FIG. 1A is shown. The water filter 116 is also shown. The water filter 116 may have threads 120 that are used to screw into the upper housing 104a, thereby preventing water that enters into the death faucet water filter 100 from bypassing the water filter 116. It should be understood that water filtration material may be disposed within the water filter 116. Above or integrated with the water filter 116 is a filter input structure that defines evenly distributed holes 124 to enable water that enters into the bath faucet water filter to be evenly distributed across the water filter 116.

The lower housing 104b may include threads 126 disposed at the top region of the lower housing 104b. The threads 126 may be utilized to screw into opposing threads (not shown) at a bottom portion of the upper housing 104a, thereby securing the upper and lower housings 104 to one another. The base drainage member 114 may be positioned at the bottom of the lower housing 104b, and configured to be retained therein. The base drainage member 114 may define holes 128 that are evenly distributed along a circular portion 130 about a center region 132 defined by a rim 134. The center region 132 may enable a treatment element 136 to be placed or otherwise positioned thereat, and the rim 134 may maintain the treatment element 136 at the center region 132. The treatment element 136 may be a skin treatment element, fragrance treatment element, bubble making treatment element, soap treatment element, or any other type of treatment element. The treatment element 132 may be a solid and be water soluble at a rate that matches the flow of water through the water filter 116. In an alternative embodiment, the treatment element 132 may include a housing through which water is able to pass with a semi-solid or liquid for treating the water, skin, making bubbles, or otherwise.

The treatment element 136 may have a height H in width W, where the width W has a longer dimension than the dimension of the height H (i.e., the treatment element 136 is wider than it is tall so as to take up less vertical space when disposed within the lower housing 104b. The treatment element 136 may have features 138 that are in the form of pedals or any other geometric or nongeometric shape. In an embodiment, a logo 140 may be formed in a center region of the treatment element 136. Although not shown, a structure, such as a rotational or vertical moving structure, that may limit or prevent water from flowing across the treatment element 132 in a close or OFF state and enable water to flow across the treatment element 132 in an open or ON state. A control feature (not shown) that controls the structure may enable a user to control the use or non-use of the treatment element 136 when utilizing the bath faucet water filter 100. In an embodiment, the upper housing 104a may have a lip 138 that defines a circumference of the opening 118 so as to limit or minimize water splashing from the opening 118 when being poured into the bath faucet water filter 100. Any other type of splash guard may be utilized in accordance with the principles described herein, including, but not limited to, a structural splash guard that extends across the opening 118.

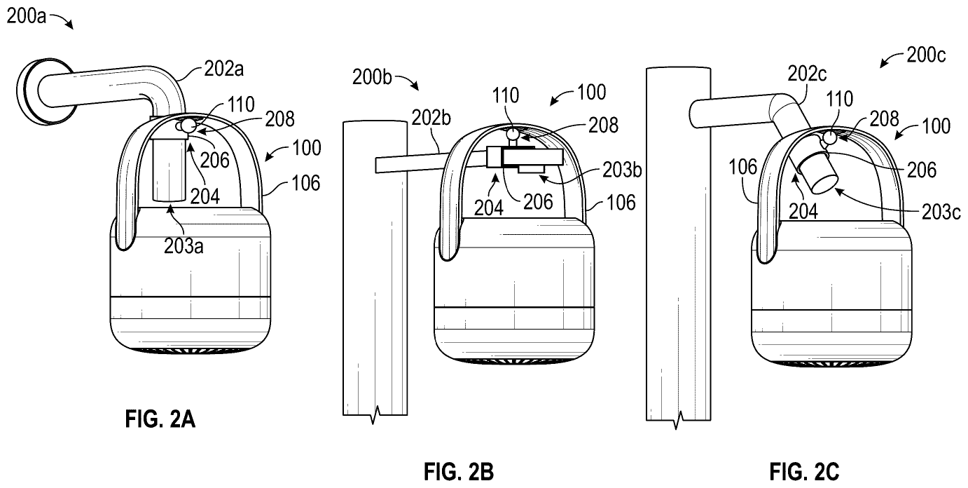

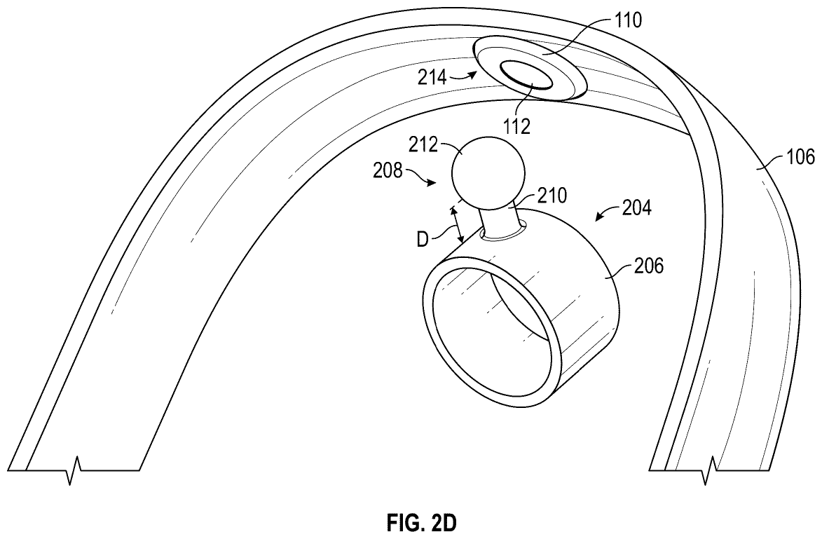

With regard to FIGS. 2A-2D, illustrations of illustrative scenes or configurations 200a-200c in which the bath faucet water filter 100 of FIGS. 1A-1G are shown to be supported by bath faucets 202a-202c are shown. Bath faucet 202a includes a spout 203a (e.g., final pathway to output opening) that is vertical or 90° from horizontal, bath faucet 202b has a horizontal spout 203b that extends 0° from horizontal, and bath faucet 202c has a diagonal spout 203c that is 45° or any other angle from horizontal. The spouts may be considered a final portion of a bath faucet from which water exits. The water that exits the bath faucet exits the opening at the end of the spout. The term bath faucet and spout may be used interchangeably with regard to a pipe or other water structure from which water flows into a bath.

To support the bath faucet water filter 100 from any of the bath faucets 202a-202c, a universal bath faucet connector 204 may be utilized. The universal bath faucet connector 204 may include a strap 206 and hanger member 208. The strap 206 and hanger member 208 may be integrated with one another such that the hanger member 208 extends perpendicular from the strap 206. In an embodiment, the strap may be flexible (capable of being bent), semi-rigid (resistant to, but capable of being bent), or rigid (not easily bent), as further described herein. In each of the scenes 200a-200c, the bath faucet water filter 100 has the opening 118 vertically aligned with the opening at the end of the spouts 203a-203c so that water that exits the spouts 203 enter into the opening 118. As shown, the hanger member 208 may have a spherical feature that may be positioned at the adapter interface structure 110 of the handle 106, as further described herein.

With regard to FIG. 2D, a zoomed-in view of the handle 106 and universal bath faucet connector 204 are shown. The handle 106 may include the adapter interface structure 110 that may be molded from or separately attached to the handle 106 and that defines an adapter interface structure engagement region 112 in which the universal bath faucet connector 204 engages. The universal bath faucet connector 204 may include a strap 206 that may be flexible so as to be able to bend around a water faucet of any variety (e.g., different sizes, shapes, configurations, lengths, surfaces, materials, etc.) and the hanger member 208 that may include a shaft 210 and head 212.

In an embodiment, the head 212 may be spherical and may be larger than the shaft 210. A distance D from the base (at the outer surface of the strap 206 extending to an outermost center point of the head 212) may be a minimum distance at which may be aligned with the adapter interface structure engagement region 112 to be able to support the bath faucet water filter 100 when the universal bath faucet connector 204 is engaged with a bath water faucet 202a or spout 203a that is vertical, such as shown in FIG. 2A. The distance D may be longer than one half the width W of the handle 106 to enable the bath faucet water filter 100 to be in an upright position in any of the configurations 200a-200c, as shown in FIGS. 2A-2C.

The universal bath faucet connector 204 come in different sizes and/or shapes. For example, the strap 206 may have different dimensions for small, medium, and large (or other sizing parameters) bath water faucets. Similarly, the hanger member 208 may come in different sizes for each of the different sized universal bath faucet connector 204. Alternatively, the hanger member 208 may be a single size for each different sized universal bath faucet connector 204. In an embodiment, the strap 206 may be configured to enable the hanger member 208 to be engaged thereto so that a kit with multiple sized straps and only one hanger member 208, which is more expensive due to having additional hardware used to form the hanger member 208, may enable a user to select one of the straps and form the universal bath faucet connector 204 by engaging or connecting the hanger member 208 with the selected strap 206. For example, an opening or slot defined by the strap 206 may enable a base portion of the hanger member 208 that may flair and remain within or along an inside surface of the strap 206 may enable the strap 206 and hanger member 208 to be coupled or retained with one another.

A magnetic mount 214 disposed within or behind the adapter interface structure engagement region 112 may be configured to support a magnet (see FIG. 4A) to attract a metallic ball (not shown) disposed within the head 212 may be utilized. The universal bath faucet connector 204 may include a silicone or other thermoplastic over mold that provides friction and to the bath water faucet and between the head 212 and adapter interface structure engagement region 112 and/or adapter interface region 110 thereby maintaining integrity of the engagements between the components when the bath faucet water filter 100 is being utilized.

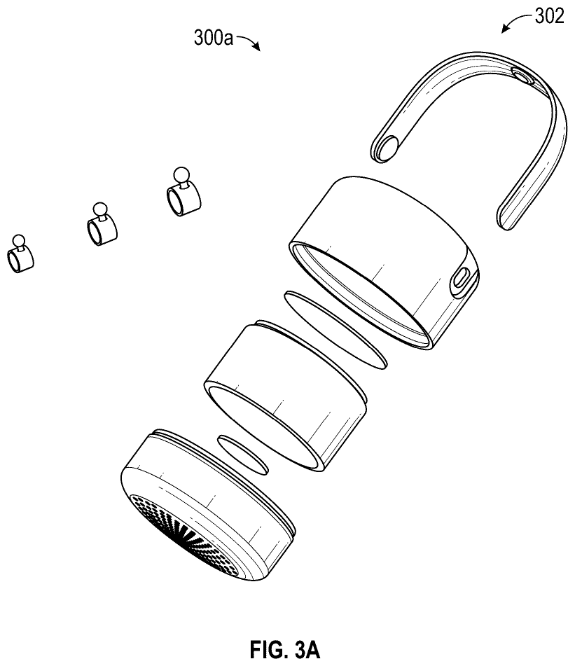

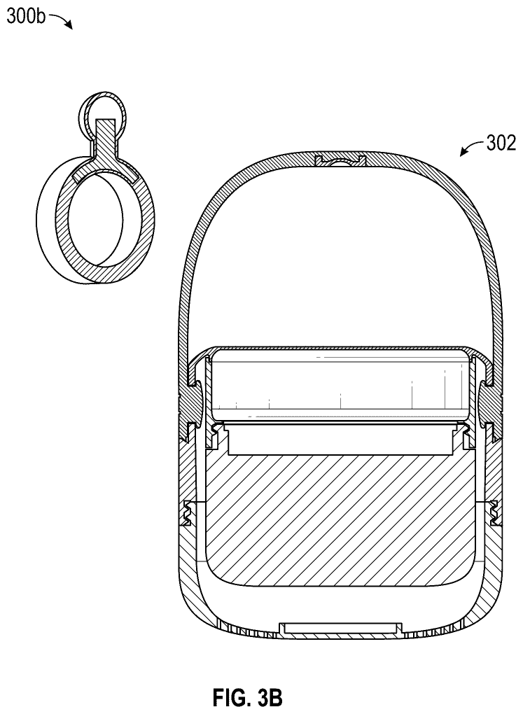

With regard to FIGS. 3A and 3B, exploded and side assembled views 300a and 300b, respectively of an illustrative bath faucet water filter 302 and components thereof are shown. The exploded view of FIG. 3A shows a magnet mount in which a magnet may be positioned at the top and center of the handle. The upper housing or a structural member that engages thereto may provide for threads that a top portion of the water filter screws into so as to be retained in portion and water that enters into the top of the bath faucet water filter 302 is forced to pass into the water filter. As shown in FIG. 3B, the universal bath faucet connector may include a plastic insert that extends within a portion of the strap shaft or neck to a steel ball disposed in the head so as to be magnetically attracted to the magnet disposed at the top of the handle.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A bath faucet water filter, comprising:
a universal bath faucet connector including a strap and a hanger member that is configured to extend from the strap when the strap is engaged with a bath water faucet; and
a bath water filter housing that defines a cavity within which a replaceable water filter is positioned, and configured to be suspended by the hanger member in an upright position when the hanger member extends horizontally, vertically, or diagonally when the strap is engaged with a corresponding bath water faucet.

2. The bath faucet water filter according to claim 1, wherein the strap is a flexible strap.

3. The filter according to claim 2, wherein the flexible strap includes a silicone surface that interfaces with the bath water faucet to minimize or prevent translation of the universal bath faucet connector.

4. The filter according to claim 1, wherein the universal bath faucet connector further includes a structural member that engages the strap and hanger member.

5. The filter according to claim 4, wherein the structural member is integrated with the hanger member.

6. The filter according to claim 5, wherein the structural member is formed of a thermoplastic material.

7. The filter according to claim 1, wherein the hanger member includes a base, shaft, and head, the shaft being larger than a horizontal width of the strap.

8. The filter according to claim 7, wherein the universal bath faucet connector further includes a magnet, and wherein the head includes a metallic component disposed thereat, and wherein the magnet is fixedly positioned at a center region of the strap such that the magnet and metallic component are magnetically coupled with one another, and an input aperture of the bath water filter housing being vertically positioned beneath an output of the bath water faucet to enable water from the bath water faucet to enter the bath water filter housing so has to be filtered by the replaceable water filter disposed there in.

9. The filter according to claim 8, wherein the strap finds at least one protrusion at the center of region to limit the head of the hanger member from moving relative to the strap while water from the bath water faucet is being input to the bath water filter housing.

10. The filter according to claim 9, wherein the strap for the defines and indentation within a center of region defined by the at least one protrusion, at least one protrusion being circular in shape along an outer surface of the strap opposing an inner surface that engages the bath water faucet.

11. The filter according to claim 8, wherein the metallic components is at least in part vertical.

12. The filter according to claim numeral 11, wherein the metallic component is positioned within a deformable material.

13. The filter according to claim 12, wherein the deformable material is a thermoplastic material.

14. The filter according to claim 12, wherein the metallic component further defines a shaft and a base that are disposed within the deformable material, the shaft extending substantially perpendicularly from the base.

15. The filter according to claim 1, wherein the bath water filter housing includes a top portion and a bottom portion that are configured to be engaged to one another, and, when disengaged from one another, enable the replaceable water filter to be exchanged with another replaceable water filter.

16. The filter according to claim 15, wherein the top portion of the bath water filter housing defines an opening including a rim surrounding the opening to reduce water from splashing out of the opening when water is being dispensed into the bath water filter housing from the bath water faucet.

17. The filter according to claim 15, wherein the bottom portion is configured to enable a treatment component to be positioned downstream from the replaceable water filter prior to filtered water from the being output from the bath, water filter, treatment component while the filtered water flows over the treatment component.

18. The filter according to claim 17, further comprising a structural member including at least one feature that retains the treatment component while the filtered water flows over the treatment component.

19. The filter according to claim 17, wherein the treatment component is a skin treatment component.

20. The filter according to claim 17, wherein the treatment component has a longer width than height.
